(19) United States
(12) Patent Application Publication
(10) Pub. No.: US 2001/0020404 A1
(43) Pub. Date: Sep. 13, 2001

(54) Wrench with reliable sliding movement for a movable jaw thereof

(76) Inventor: Chiu-Man Chang-Kao, Taichung Hsien (TW)

Correspondence Address: RIDER BENNETT EGAN & ARUNDEL, 333 South Seventh Street, Suite 2000, Minneapolis, MN, 55402-1609, US

(21) Appl. No.: 09/789,112

(22) Filed: Feb. 20, 2001

(30) Foreign Application Priority Data
Mar. 10, 2000 (TW) 89203822

(51) Int. Cl. B25B 13/12

(52) U.S. Cl. 81/127

(57) ABSTRACT

A wrench comprises a handle including an end having two lobes, a main jaw, and a movable jaw. The main jaw comprises a first main jaw piece and a second main jaw piece that are formed by pressing. Each of the first main jaw piece and the second main jaw piece includes a first end pivotally connected to the end of the handle and a second end for clamping. Each of the first main jaw piece and the second main jaw piece further includes a track. The movable jaw comprises a first movable jaw piece and a second movable jaw piece that are formed by pressing. Each of the first movable jaw piece and the second movable jaw piece includes a first end having two arcuate recesses for cooperating with the lobes and a second end for clamping. A block is mounted in the first movable jaw piece and the second movable jaw piece and has two ends extending into the tracks of the first main jaw piece and the second main jaw piece, respectively. The block slides along the tracks of the first main jaw piece and the second main jaw piece when the first movable jaw piece and the second movable jaw piece slide relative to the first main jaw piece and the second main jaw piece in response to pivotal movement of the first main jaw piece and the second main jaw piece relative to the handle.

### BACKGROUND OF THE INVENTION

The present invention relates to a wrench of the type having a main jaw pivotally connected to a handle and a movable jaw that is movable relative to the main jaw, wherein the movable jaw slides relative to the main jaw when the main jaw is pivoted relative to the handle.

Such a wrench is shown in FIG. 6 of the drawings, wherein the wrench includes a handle 70, a main jaw 71 pivotally mounted to an end of the handle 70, and a movable jaw 74 having a portion 72 engaged with the end of the handle 70 in a manner that the movable jaw 74 slides relative to the main jaw 71 when the main jaw 71 is pivoted relative to the handle 70, thereby adjusting a distance between the main jaw 71 and the movable jaw 74 in response to objects having various sizes. Nevertheless, the sliding motion of the movable jaw 74 is not reliable such that the main jaw 71 and the movable jaw 74 cannot clamp the object therebetween, as the movable jaw 74 might inadvertently slide relative to the main jaw 74. In addition, conventional wrenches of this type are manufactured by forging for rough production, and minor portions of the wrenches must be processed by additional processing. Forging requires a forging furnace operating at high temperature and thus has the risk of fire, explosion, and air pollution. In addition, noise is inevitable, as hammering is necessary for forming the products. Furthermore, manufacturers must produce at least twenty thousands of wrenches for each mold to lower the manufacture cost, yet the stock cost is incurred.

### SUMMARY OF THE INVENTION

It is the primary object of the present invention to provide an improved wrench of the above-mentioned type, wherein the wrench is manufactured by pressing to lower the cost. In addition, the assembly for the wrench is easy by means of simple riveting.

It is another object of the present invention to provide an improved wrench of the above-mentioned type, wherein sliding movement of the movable jaw relative to the main jaw is guided by slots defined in the movable jaw and the main jaw.

A wrench in accordance with the present invention comprises:

a handle including an end having two lobes;

a main jaw comprising a first main jaw piece and a second main jaw piece that are formed by pressing, each of the first main jaw piece and the second main jaw piece including a first end pivotally connected to the end of the handle and a second end for clamping, each of the first main jaw piece and the second main jaw piece further including a track;

a movable jaw comprising a first movable jaw piece and a second movable jaw piece that are formed by pressing, each of the first movable jaw piece and the second movable jaw piece including a first end having two arcuate recesses for cooperating with the lobes and a second end for clamping; and

a block mounted in the first movable jaw piece and the second movable jaw piece and having two ends extending into the tracks of the first main jaw piece and the second main jaw piece, respectively;

wherein the block slides along the tracks of the first main jaw piece and the second main jaw piece when the first movable jaw piece and the second movable jaw piece slide relative to the first main jaw piece and the second main jaw piece in response to pivotal movement of the first main jaw piece and the second main jaw piece relative to the handle.

The first main jaw piece and the second main jaw piece comprise at least one reinforcing clamping piece mounted therebetween. The second end of the first main jaw piece, the reinforcing clamping piece, and the second end of the second main jaw piece are riveted together. The first movable jaw piece and the second movable jaw piece comprise at least one reinforcing clamping piece mounted therebetween. The second end of the first movable jaw piece, the reinforcing clamping piece, and the second end of the second movable jaw piece are riveted together. The handle includes at least one handle piece that is formed by pressing. The resultant structure is as strong as that of a wrench manufactured by forging.

Each of the tracks of the first main jaw piece and the second main jaw piece is an elongated slot. The second end of each of the first main jaw piece and the second main jaw piece has a notch and the second end of each of the first movable jaw piece and the second movable jaw piece has a notch, thereby providing the function of a pair of pliers.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a wrench in accordance with the present invention.

FIG. 2 is a perspective view of the wrench in accordance with the present invention.

FIG. 3 is a top view of the wrench in accordance with the present invention.

FIG. 4 is a top view similar to FIG. 3, wherein the wrench is in a position for clamping an object of a smaller size.

FIG. 5 is a top view similar to FIG. 4, wherein the wrench is in a position for clamping an object of a larger size.

FIG. 6 is a perspective view of a conventional wrench.

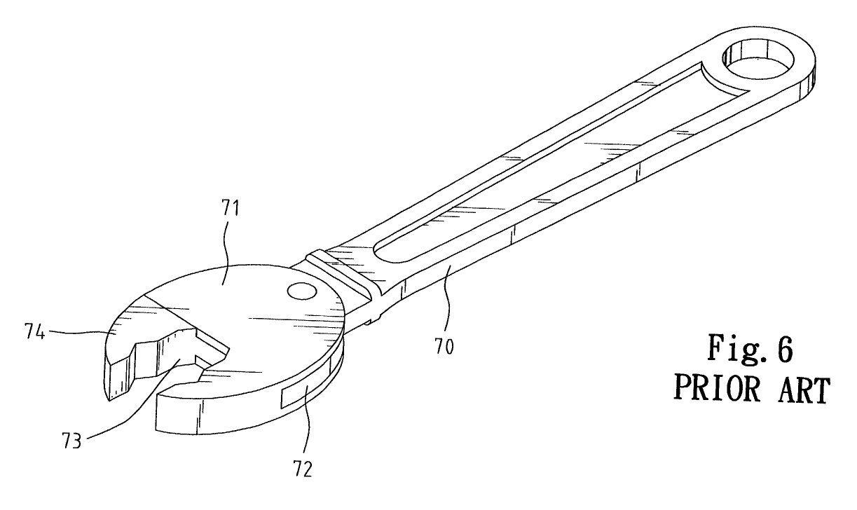

### DETAILED DESCRIPTION OF THE PREFERRED EMBODIMENT

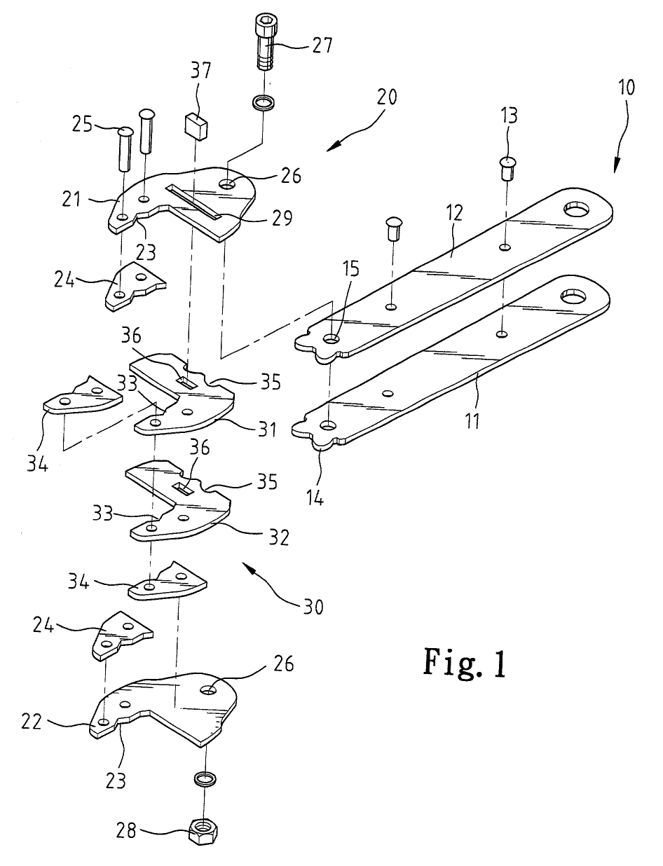

Referring to FIGS. 1 through 3, a wrench in accordance with the present invention generally includes a handle 10 consisting of two handle pieces 11 and 12 that are riveted together by rivets 13. Each handle piece 11, 12 includes an end having two lobes 14 projected outward and a pivot hole 15 defined therein.

The wrench further includes a main jaw 20 consisting of a first main jaw piece 21 and a second main jaw piece 22. Each main jaw piece 21, 22 has a notch 23 on an end thereof so as to provide the function of a pair of pliers. At least one reinforcing clamping piece 24 (two in this case) is mounted between the end of the first main jaw piece 21 and the end of the second main jaw piece 22 for providing reliable clamping. Each reinforcing clamping piece 24 has a notch configured identical to that of the main jaw piece 21, 22. The main jaw pieces 21 and 22 and the reinforcing clamping pieces 24 are riveted together by rivets 25. The strength of the resultant structure is the same as that of a wrench manufactured by forging.

The other end of each main jaw piece 21, 22 has a pivot hole 26. A screw or bolt 27 is extended through the pivot hole 26 of each main jaw piece 21, 22 and the pivot hole 15 of each handle piece 15, thereby pivotally connecting the main jaw pieces 21 and 22 to the handle pieces 11 and 12.

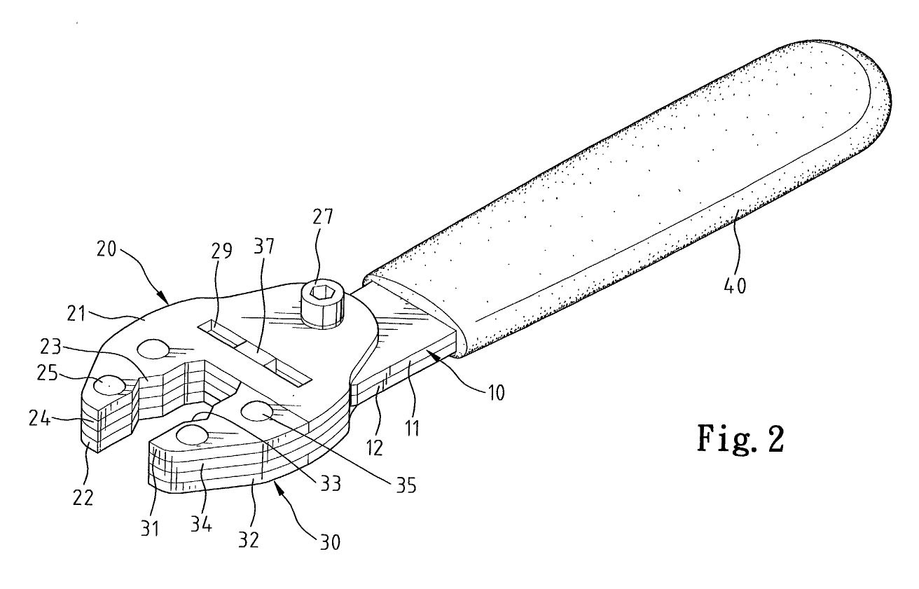

The wrench further includes a movable jaw 30 consisting of a first movable jaw piece 31 and a second movable jaw piece 32. An end of each movable jaw piece 31, 32 has a notch 33 on an end thereof so as to provide the function of a pair of pliers. At least one reinforcing clamping piece 34 (two in this case) is mounted between the end of the first movable jaw piece 31 and the end of the second movable jaw piece 32 for providing reliable clamping. Each reinforcing clamping piece 34 has a notch configured identical to that of the movable jaw piece 31, 32. The movable jaw pieces 31 and 32 and the reinforcing clamping pieces 34 are riveted together by rivets 35 (FIG. 2). The strength of the resultant structure is the same as that of a wrench manufactured by forging. The other end of each movable jaw piece 31, 32 has two arcuate recesses 35 for cooperating with the lobes 14 of the handle pieces 11 and 12.

Each main jaw piece 21, 22 has a track, e.g., an elongated slot 29, and each movable jaw piece 31, 32 has a slot 36. A block 37 is extended through the slots 36 of the movable jaw pieces 31 and 32 and has two ends extending into the elongated slots 29 of the main jaw pieces 21 and 22, respectively. Thus, the movable jaw 30 slide smoothly and stably relative to the main jaw 20 along the elongated slots 29 when the main jaw 20 is pivoted relative to the handle 10.

Referring to FIG. 2, a jacket 40 made from plastic or soft material may be provided to the handle 10 to provide a comfort holding.

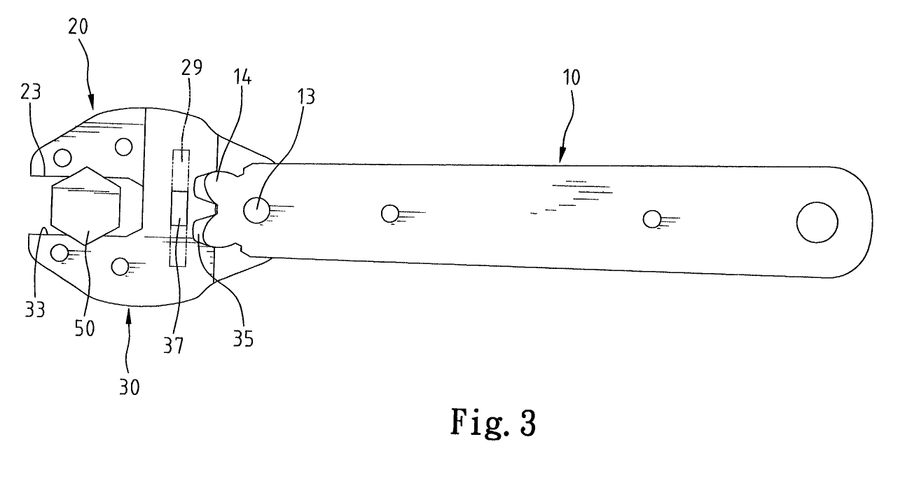

Referring to FIG. 3, when the main jaw 20 and the movable jaw 30 are in a middle position, the clamping portions 23 and 33 thereof have a gap therebetween suitable for clamping an object (e.g., a nut) of a medium size. It is noted that the lobes 14 of the handle 10 are received in the arcuate recesses 35 of the movable jaw 30. In addition, the block 37 is located in a middle of each elongated slot 29.

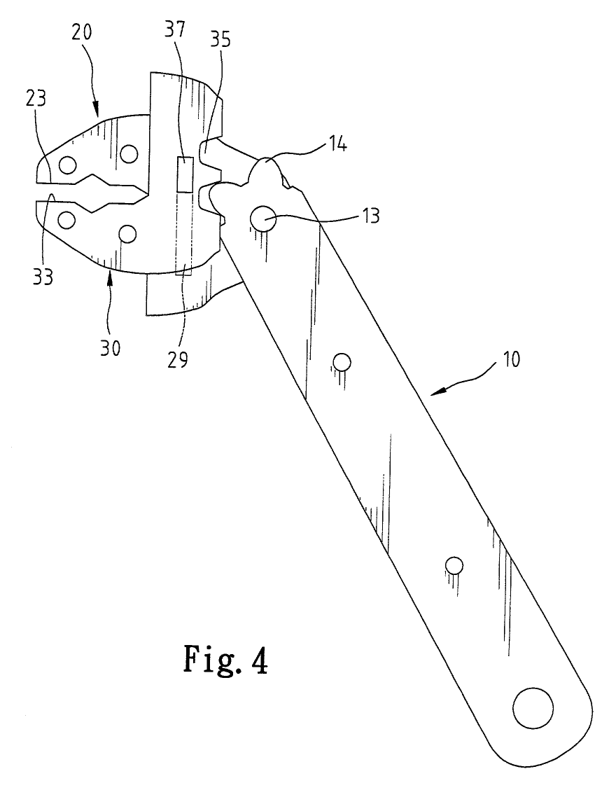

When the main jaw 20 is pivoted relative to the handle 10 to a position shown in FIG. 4, only one of the lobes 14 (the left one in FIG. 4) of each main jaw piece 21, 22 is engaged in the associated arcuate recess 35 of each movable jaw piece 31, 32. The block 37 slides to an upper end of the elongated slot 29 of each main jaw piece 21, 22. Thus, the clamping portions 23 and 33 have a gap therebetween suitable for clamping an object (e.g., a nut) of the smallest size that can be clamped by the wrench.

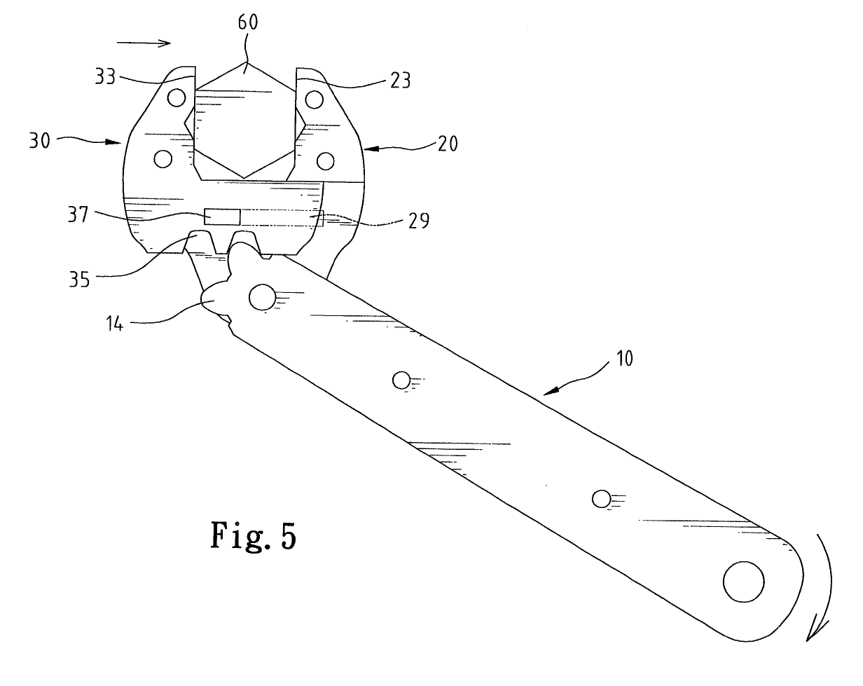

When the main jaw 20 is pivoted relative to the handle 10 to a position shown in FIG. 5, only one of the lobes 14 (the right one in FIG. 5) of each main jaw piece 21, 22 is engaged in the associated arcuate recess 35 of each movable jaw piece 31, 32. The block 37 slides to a lower end of the elongated slot 29 of each main jaw piece 21, 22. Thus, the clamping portions 23 and 33 have a gap therebetween suitable for clamping an object (e.g., a nut) of the largest size that can be clamped by the wrench.

In use, as illustrated in FIG. 5, when the user turns the handle 10 along a direction indicated by an arrow in FIG. 5, the movable jaw 30 moves rightward to securely clamp the object (e.g., a nut 60). The nut 60 is thus tightened. For loosening the nut 60, the user may turn the wrench upside-down, re-engage the wrench with the nut 60, and turn the handle 10 in a reverse direction.

It is noted that the handle pieces 11 and 12, the main jaw pieces 21 and 22, and the movable jaw pieces 31 and 32 are formed by pressing and thus have a low cost. Manufacture of the pieces 11, 12, 21, 22, 31, and 32 by pressing is rapid, and assembly of the pieces 11, 12, 21, 22, 31, and 32 can be easily achieved by riveting. In addition, relative sliding motion of the movable jaw 30 relative to the main jaw 20 is reliable by means of provision of the slots 29 and 36 and the block 37 engaged in the slots 29 and 36.

Although the invention has been explained in relation to its preferred embodiment, it is to be understood that many other possible modifications and variations can be made without departing from the scope of the invention as hereinafter claimed.

What is claimed is:

1. A wrench comprising:
a handle including an end having two lobes;
a main jaw comprising a first main jaw piece and a second main jaw piece that are formed by pressing, each of the first main jaw piece and the second main jaw piece including a first end pivotally connected to the end of the handle and a second end for clamping, each of the first main jaw piece and the second main jaw piece further including a track;
a movable jaw comprising a first movable jaw piece and a second movable jaw piece that are formed by pressing, each of the first movable jaw piece and the second movable jaw piece including a first end having two arcuate recesses for cooperating with the lobes and a second end for clamping; and
a block mounted in the first movable jaw piece and the second movable jaw piece and having two ends extending into the tracks of the first main jaw piece and the second main jaw piece, respectively;
wherein the block slides along the tracks of the first main jaw piece and the second main jaw piece when the first movable jaw piece and the second movable jaw piece slide relative to the first main jaw piece and the second main jaw piece in response to pivotal movement of the first main jaw piece and the second main jaw piece relative to the handle.

2. The wrench as claimed in claim 1, wherein the first main jaw piece and the second main jaw piece comprise at least one reinforcing clamping piece mounted therebetween.

3. The wrench as claimed in claim 2, wherein the second end of the first main jaw piece, said at least one reinforcing clamping piece, and the second end of the second main jaw piece are riveted together.

4. The wrench as claimed in claim 1, wherein the first movable jaw piece and the second movable jaw piece comprise at least one reinforcing clamping piece mounted therebetween.

5. The wrench as claimed in claim 4, wherein the second end of the first movable jaw piece, said at least one reinforcing clamping piece, and the second end of the second movable jaw piece are riveted together.

6. The wrench as claimed in claim 1, wherein the handle includes at least one handle piece that is formed by pressing.

7. The wrench as claimed in claim 1, wherein each of the tracks of the first main jaw piece and the second main jaw piece is an elongated slot.

8. The wrench as claimed in claim 1, wherein the second end of each of the first main jaw piece and the second main jaw piece has a notch.

9. The wrench as claimed in claim 1, wherein the second end of each of the first movable jaw piece and the second movable jaw piece has a notch.
